(19) United States
(12) Patent Application Publication
(10) Pub. No.: US 2002/0118373 A1
(43) Pub. Date: Aug. 29, 2002

(54) Method for detecting movement of a sample primarily for use in magnetic resonance imaging of the sample

(76) Inventors: Hadass Eviatar, Winnipeg (CA); Bernhard J. Schattka, Winnipeg (CA); Murray Ellis Alexander, Winnipeg (CA); Jonathan Curnow Sharp, Winnipeg (CA); Jeremy Joseph Roshick, Winnipeg Beach (CA); Arthur Randolph Summers, Winnipeg (CA)

Correspondence Address: Adrian D. Battison, Ade & Company, 1700-360 Main Street, Winnipeg, MB, R3C 3Z3, CA

(21) Appl. No.: 09/988,095

(22) Filed: Nov. 19, 2001

Related U.S. Application Data
(63) Continuation-in-part of application No. PCT/CA00/00556, filed on May 15, 2000.
(60) Provisional application No. 60/134,867, filed on May 19, 1999.

(51) Int. Cl. G01B 11/14

(52) U.S. Cl. 356/614

(57) ABSTRACT

Motion artefacts are a major hindrance in magnetic resonance (MR) imaging applications, particularly functional imaging and other high-sensitivity applications. The system as disclosed provides a versatile laser ranging method for the measurement of body part rotation and translation, simultaneously in three dimensions. Since optical motion detection and NMR data acquisition are inherently independent, these two systems can function efficiently in parallel. Furthermore, using these optical motion data, real-time image artefact correction can be achieved by passing the appropriate parameters to the pulse programmer to change the acquisition in real time. The system uses three laser diodes mounted on a fixed platform and generating converging beams impinging on three retro-reflectors to generate three parallel but offset reflected beams the positions of which are detected by position sensing detectors providing two output signals indicative of the position of the beam in the plane of the detector. A mounting assembly for a frame of the reflectors is provided which mounts a frame supporting them on a headphone structure on the patient head. A calculation is provided which locates the position of the frame in the coordinates of the magnet to allow the NMR experiments to compensate for detected movement of the patient's head.

This application is a continuation-in-part application from PCT/CA00/00556 filed May 15, 2000 and now abandoned.

This application claims priority under 335USC119 from Provisional Application 60/134867 filed May 19, 1999.

This invention relates to a method for detecting movement of a sample, which is particularly, but not exclusively, designed and arranged for use in magnetic resonance (MR) imaging of the sample. The method may be used to provide real-time motion correction for the magnetic resonance imaging. In separate aspects, the method provides a hardware arrangement for effecting the detection, a calculation algorithm, which can be used in the detection, and a technique for mounting the detection elements on the sample where the sample is the head of a patient within the MR magnet.

### BACKGROUND OF THE INVENTION

Motion artefacts are a major hindrance in magnetic resonance imaging applications, particularly functional imaging and other high-sensitivity applications.

MR images cannot be acquired instantaneously, and for some applications, for example the imaging of brain function by the BOLD method (Blood Oxygen Level Dependent), a series of images must be acquired and compared. Any discrepancies caused by motion during the entire time course, which can last several minutes, can hamper the analysis of the time course data and result in artefacts in derived maps. Laborious registration and other post processing must precede any meaningful comparison of images, and often it is not clear that a series of measurements may be unusable until after the experiment is over, causing much inconvenience and waste of time and resources.

Many different solutions have been brought to bear on this problem, ranging from severe restraint of the subject's head or limb to the use of navigator echoes [1]. While strong restraints, such as thermoplastic masks or bite bars (in the case of head imaging), certainly reduce the amount of subject motion, they can be experienced as uncomfortable or frightening, particularly in the case of geriatric, paediatric or epileptic subjects, or in veterinary imaging.

Another popular solution, the use of navigator echoes, involves the measurement of additional MR echo signals from the subject. This is followed by the use of characteristics of the signal which reveal information about motion (frequency of an anatomical feature, or signal phase) to modify the acquisition protocol in real time or to modify the post-processing of data. Navigator echoes can be effective, but suffer from a number of limitations. They require the use of the full MRI imaging system, laying claim to valuable machine resources; they complicate the acquisition protocol and pulse programming; they take time to acquire and so reduce the efficiency of data acquisition. This last point is particularly significant for multislice functional MRI where time is at a premium. Navigator echoes also disturb the magnetisation of the subject, thereby interfering with the imaging process, which is based on measurement of this magnetisation. Furthermore, a single echo provides information along a single axis only. For full characterisation of motion multiple echoes are required. In this case the interference with the data acquisition becomes more severe and the temporal resolution suffers. An example of the above technique is disclosed in U.S. Pat. No. 4,937,526 of Ehman et al and Ehman has been a leading proponent of this technique generating a number of related patented improvements.

Siemens in U.S. Pat. No. 6,023,636 issued Feb. 8, 2000 and General Electric in U.S. Pat. No. 5,947,900 issued Sep. 7, 1999 disclose arrangements for detecting patient movement by means of additional NMR receiver coils.

In addition, Siemens in DE Application 197 25 137 A1 disclose a proposal for detecting movement of a catheter tip in the patient using magnetic detection systems for use in real time correction of X-ray imaging.

U.S. Pat. No. 4,972,836 of General Electric issued Nov. 27, 1990 discloses a method for detecting movement of the sample, for example the human eye, using optical sensors, and for using only those images where no movement has been detected.

U.S. Pat. No. 5,446,548 of Siemens issued Aug. 25, 1995 discloses a method of detecting the position of the sample part of the patient by detecting reflected radiation from the target on the sample by cameras. The presence of motion is transmitted to the operator.

U.S. Pat. No. 5,265,609 of Biomagnetic Technologies issued Nov. 30, 1993 discloses a method of detecting movement of the position of the sample part of the patient by detecting changes in reflected radiation from a target on the sample. The presence of motion is transmitted to the operator or is used to halt taking of measurements.

The following references also are relevant:

[1] Lee, C. C. et.al., Mag. Res. Med., 36, 436-444, 1996 which discloses navigator echoes to correct motion during acquisition of MR images

[symbol]

[2] Press, W. H., et.al., Numerical Recipes in C, 2^{nd} edition, 1992, Section 9.7 discloses a Newton-Raphson numerical algorithm and source code for finding solution to a non-linear system of equations.

[3] Goldstein, S. R. et.al., IEEE Trans. Med. Imag., 16 17, 1997, describes a real-time head motion measurement system using optical triangulation of 3 lights attached to patient's head and 2 position sensing devices

[symbol]

[4] Wells, D. L., Li, L. C., and Cox, B. J., U.S. Pat. No. 5,673,082, September 1997 describes a ranging system comprised of a video camera with attached light source and a remote target.

[5] Eviatar, H., Saunders, J. K., and Hoult, D. I., ISMRM 1997, Vancouver, p. 1898 discloses a method for rapid computation of rotation and translation from the motion of 3 fiducial points attached to a rigid frame.

### SUMMARY OF THE INVENTION

It is one object of the present invention therefore to provide an improved method of detecting the position of a sample.

According to a first aspect of the invention there is provided a method for detecting movement of a sample comprising:

providing three retro-reflectors:

rigidly attaching the three retro-reflectors in an array to the sample such that movement of the object effects movement of one, two or all of the retro-reflectors, depending upon the movement of the sample;

providing three light sources, each arranged to direct an incident light beam onto a respective one of the retro-reflectors such that the incident beam is reflected from the respective retro-reflector to generate a reflected beam which is parallel to the incident light beam and which is off-set from the incident beam by a distance dependent upon the position of the respective retro-reflector relative to the incident beam;

arranging three position sensing detectors such that each receives a respective one of the reflected light beams and so as to generate an output comprising two signals representative of a position in a plane of the position sensing detector of the point of incidence of the reflected beam on the plane such that the two signals provide information relating to the position of the respective retro-reflector;

mounting the light sources and the position sensing detectors in fixed relative positions on a platform so as to direct the incident light beams onto the respective retro-reflectors with the incident beams non-parallel;

and in response to the two signals from each of the three position sensing detectors effecting a calculation of information defining the movement of the object about three rotational axes and in three translational directions.

It will be appreciated that the number of beams and reflectors can be increased to more than three if desired, particularly where movement of a part of the body which can also articulate is to be detected. Thus where the term “three” is used herein, it is to be understood that it has the meaning of at least three.

Preferably the position sensing detectors are solid state, non-imaging photodetectors so that the two signals from the position sensing detectors are in analogue form and there is provided an analogue to digital converter for converting the signals to digital values for the calculation.

The above definition refers to the provision of three position sensing detectors. This can be effected, as in the embodiments particularly described hereinafter, by the provision of three separate photodetectors each receiving a respective beam and each separately mounted on the platform. However an alternative arrangement can be provided in which each position sensing detector includes a mirror which directs the beam to a single photodetector which acts for all three sensing detectors in a time multiplexing operation. Thus the three position sensing detectors are together defined by three mirrors, a single sensor and a time multiplexing arrangement which allows the single sensor to co-operate with the respective light beam at selected times to generate for each beam the two required signals.

Preferably the calculation is arranged: firstly to calculate from the digital values of the three position sensing detectors for each position sensing detector and its associated retro-reflector a distance between a fixed point in the plane of the position sensing detector and a predetermined point in the respective retro-reflector; and secondly to calculate, from said distances and from information defining the geometry of the position sensing detectors on said platform and the geometry of the retro-reflectors in said array, the coordinates of the predetermined points of the retro-reflectors relative to a reference point which is fixed relative to the platform.

Preferably the predetermined point of each of the retro-reflectors is located at the virtual apex thereof.

A specially designed algorithm provides a preferred calculation which uses the following formula:

zⱼ²+zₖ²−2aⱼₖzⱼzₖ+2bⱼₖzₖ−2cⱼₖzⱼ+Δⱼₖ=0 (11)

where the terms of the equation are as set out in the specification.

Preferably the output of the algorithm consists of six floating point numbers which represent the three components of the displacements of the sample along the axes of the magnet coordinate frame, and the three Euler angles describing the orientation of the sample with respect to these axes.

Preferably each light source and its associated position sensing detector includes a beam splitter for directing the reflected beam at an angle to the incident light beam for detection.

Preferably the light sources are arranged on the platform at apexes of a triangle in a plane of the platform such that the beams are projected to one side of the plane containing the light sources and such that the beams converge with each other.

Preferably the beams converge with each other at an angle which is the maximum which can be accommodated for the geometry concerned and in the case where the method is used in NMR with a cylindrical magnet, the beams are arranged preferably to pass just inside the inner periphery of the magnet and to converge to a point at the sample with the retro-reflectors intersecting the beams at the array.

Preferably the retro-reflectors are mounted on a frame at apexes of a triangle, the frame being attached to the sample for movement therewith.

While the method can be used for detecting movements of a sample in many different situations including on a microscopic scale, it is primarily designed for use in NMR experiments where the method includes the steps of performing magnetic resonance measurements to provide information relating to the sample by: providing at least one magnet generating a magnetic field; providing at least one gradient field coil and applying a field signal to the coil resulting in a magnetic field which in addition to the field of the magnet is applied to form a variable magnetic field in which the sample is located; providing at least one radiofrequency (RF) coil and applying an RF signal to the RF coil to generate an RF field; detecting RF signals from the sample caused by nuclear magnetic resonance in the sample; analyzing the RF signals to determine information relating to the sample; and, during the nuclear magnetic resonance measurements, using the information defining the movement of the object about three rotational axes and in three translational directions to compensate for movement of the sample such that the information relating to the sample is independent of any movement of the sample.

In one arrangement, the information defining the movement is used to vary the field signal to the gradient field coil and the RF signal to the RF coil and thus to compensate for the movement. In this arrangement, the information defining the movement is applied to a pulse programmer which is responsive thereto to generate the field signals to the gradient coils and the RF signals to the RF coil.

In an alternative arrangement, the information defining the movement is used to modify the analyzing of the RF signals from the sample.

In accordance with another important feature of the invention, where the sample comprises the head of a patient and there is provided a set of headphones worn by the patient while in the magnet, the retro-reflectors are preferably mounted on a frame attached to the headphones.

Preferably the frame includes an arch member attached to the headphones at sides of a strap thereof and bridging a top of the head of the patient and an array frame carrying the retro-reflectors and attached at a top of the arch member so as to lie in a plane generally across the top of the arch member.

Preferably the array frame is mounted on a swivel joint relative to the arch member so as to allow adjustment of the orientation of the array frame relative to the head of the patient.

According to a second aspect of the present invention there is provided a method for detecting movement of a sample comprising:

providing three non-parallel light beams each transmitted from a respective element located at a respective position on the sample;

providing three position sensing detectors and arranging the detectors at fixed positions on a platform such that each receives a respective one of the light beams and generates an output comprising two signals representative of a position in a plane of the position sensing detector of the point of incidence of the light beam, such that the signals are dependent upon movement of the sample and the elements thereon;

and effecting a calculation from the signals in digital values wherein the calculation is arranged:

firstly to calculate from the digital values of the three position sensing detectors for each position sensing detector and its associated element a distance between a fixed point in the plane of the position sensing detector and a predetermined point in the respective element;

and secondly to calculate, from said distances and from information defining the geometry of the position sensing detectors on said platform and the geometry of the elements on the sample, the coordinates of the predetermined points of the elements relative to a point at the sample which is fixed relative to the platform.

It is a further object of the present invention to provide an improved method of performing magnetic resonance experiments bearing in mind the problem of sample movement.

According to a third aspect of the present invention there is provided a method of performing magnetic resonance measurements to analyze a sample, comprising:

providing at least one magnet generating a magnetic field;

providing at least one gradient field coil and applying a field signal to the coil resulting in a magnetic field which in addition to the field of the magnet is applied to form a variable magnetic field in which the sample is located;

providing at least one radiofrequency (RF) coil and applying an RF signal to the RF coil to generate an RF field;

detecting RF signals from the sample caused by nuclear magnetic resonance in the sample;

analyzing the RF signals to determine information relating to the sample;

during the nuclear magnetic resonance measurements, detecting movements of the sample by a motion detection system which is separate from the nuclear magnetic resonance measurements to generate motion signals indicative of the movement;

and, during the nuclear magnetic resonance measurements, using the motion signals to compensate for the movement such that the information is independent of the movement.

According to a fourth aspect of the invention there is provided a method for detecting movement of a sample comprising:

providing three light sources each transmitted from a respective element located at a respective position on the sample;

providing three position sensing detectors and arranging the detectors at fixed positions on a platform such that each receives light from a respective one of the light sources and generates an output comprising two signals representative of a position in a plane of the position sensing detector of the point of incidence of the light, such that the signals are dependent upon movement of the sample and the elements thereon;

and effecting a calculation from the signals in digital values wherein the calculation is arranged:

firstly to calculate from the digital values of the three position sensing detectors for each position sensing detector and its associated element a distance between a fixed point in the plane of the position sensing detector and a predetermined point in the respective element;

and secondly to calculate, from said distances and from information defining the geometry of the position sensing detectors on said platform and the geometry of the elements on the sample, the coordinates of the predetermined points of the elements relative to a point at the sample which is fixed relative to the platform.

The above definition refers to the provision of three position sensing detectors. This can be effected, as in the embodiments particularly described hereinafter, by the provision of three separate photodetectors each receiving a respective beam and each separately mounted on the platform. However an alternative arrangement can be provided in which each position sensing detector includes a mirror which directs the beam to a single photodetector which acts for all three sensing detectors in a time multiplexing operation. Thus the three position sensing detectors are together defined by three mirrors, a single sensor and a time multiplexing arrangement which allows the single sensor to co-operate with the respective light beam at selected times to generate for each beam the two required signals.

As described in more detail hereinafter, the embodiments disclosed herein provide a method designed to address these problems. Thus a versatile laser ranging method is described for the measurement of body part rotation and translation, simultaneously in three dimensions. Since optical motion detection and NMR data acquisition are inherently independent, these two systems can function efficiently in parallel. Furthermore, using these optical motion data, real-time image artefact correction can be achieved by passing the appropriate parameters to the pulse programmer to change the acquisition in real time. The speed and accuracy of our method are enhanced by dispensing with the use of video cameras, which some workers have used in the past.

### BRIEF DESCRIPTION OF THE DRAWINGS

One embodiment of the invention will now be described in conjunction with the accompanying drawings in which:

FIG. 1 is a schematic partly cross-sectional view of the hardware components of the method arranged for use in conjunction with a patient in an NMR magnet.

FIG. 2 is a schematic drawing of one light source and its associated position sensing detector.

FIG. 3A is an isometric view showing schematically the overall geometry of the hardware components.

FIG. 3B is an isometric view showing schematically the specific geometry of the hardware components.

FIG. 4 is a schematic illustration of the geometry used in the algorithm to effect a rotation from platform to magnet coordinates.

FIG. 5 is a schematic illustration of the geometry used in the algorithm to effect an altitude-azimuth offset from platform coordinates.

FIG. 6 is a schematic illustration of the geometry of the system as used in the algorithm.

FIG. 7 is a schematic illustration of the timing diagram for the NMR gradient correction.

FIG. 8 is a schematic illustration of the linearity of the PSD output voltage with displacement of point of incidence of light beam on the plane of the PSD.

FIG. 9 is a schematic illustration of the unit vector system U, as defined relative to the retro-reflector plane

FIG. 10 is a front elevational view of a mounting assembly for attachment of the reflector array on the head of a patient.

FIG. 11 is a side elevational view of the mounting assembly of FIG. 9.

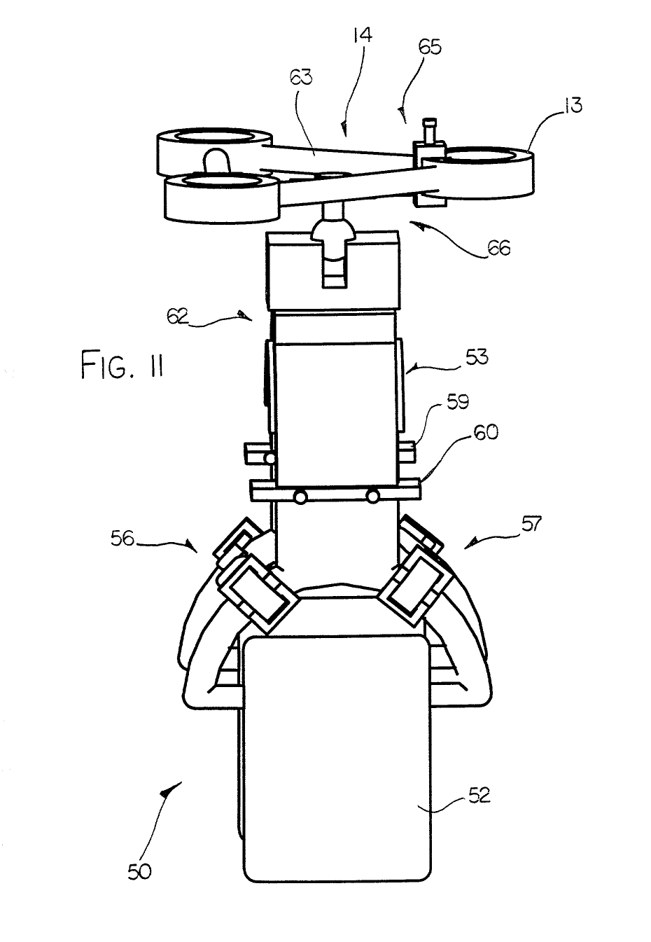

### DETAILED DESCRIPTION

The motion correction system comprises three main modules, that is the hardware, the calculation algorithm which converts the output from the hardware into position and rotation coordinates and the compensation system which uses the above position and rotation coordinates in the NMR experiments, each of which is described in more detail below.

The instrumental interfaces for the modules described were built using the software LabVIEW 5.1 (National Instruments, Austin, Tex., U.S.A.). The more computationally intensive software described below was written in C, and compiled into the LabVIEW program, using the Code Interface Node (CIN) facility and Microsoft Visual Studio V.6.0.

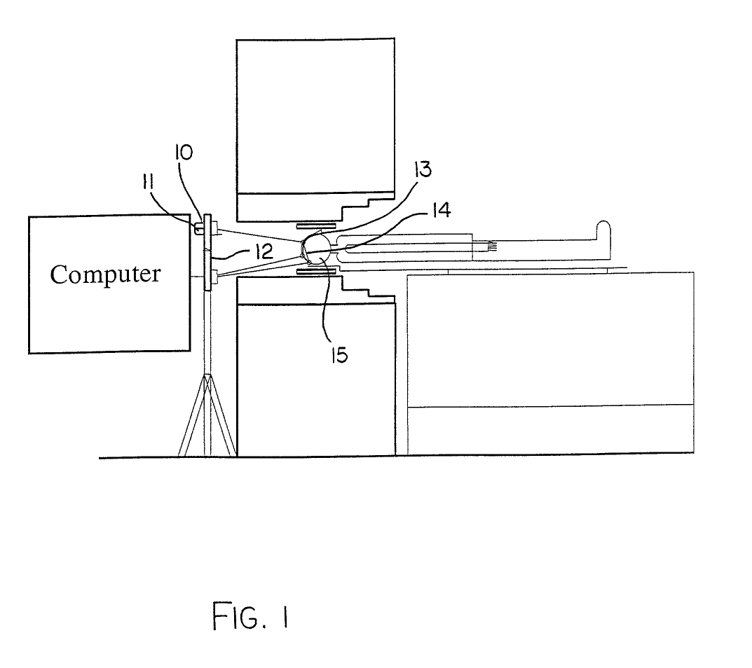

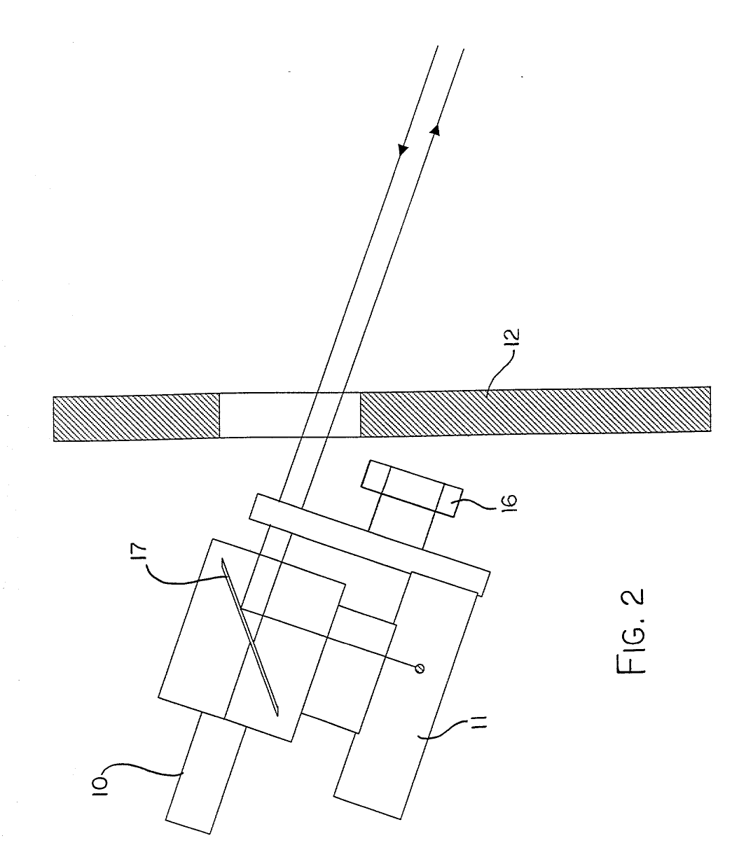

As shown in FIGS. 1 and 2, the hardware uses three semiconductor lasers 10 and three two-dimensional solid-state position-sensing detectors (PSD) 11, mounted outside the magnet bore at known locations and orientations on a rigid, fixed platform 12 by an adjustable mount 16. Three solid glass trihedral cube-corner retro-reflectors 13 are mounted rigidly on an acrylic frame 14 attached to the sample 15. The frame 14 is attached rigidly to the subject's body part by a mounting arrangement described in more detail hereinafter. The lasers pass the beam through a splitter 17. The beams are arranged so as to be non parallel and to converge toward the sample. The reflectors on the frame 14 are adjusted so that their virtual apex is close to the incident beam. The laser diodes are mounted at the apexes of a triangle in the plane of the platform and so as to direct the beam into the bore of the magnet at an angle of convergence which is the maximum which can be accommodated while passing just inside the inner periphery of the magnet. The reflectors are arranged on the frame so that they intercept each beam before it reaches the point of convergence. Thus the reflectors are also mounted in a plane of the frame 14 at the apexes of a triangle. In an initial position of the system, the platform and the frame define approximately parallel planes.

Each laser illuminates a reflector, and each reflected beam which is exactly parallel to the incoming beam is sensed by its position-sensing detector (PSD), after reflection by the respective beam splitter 16, which is mounted on the same platform as the corresponding laser. The position and orientation information for othe three laser-PSD locations defines the geometry of the device.

The PSDs provide an analogue current, which is directly proportional to the position of the centroid of a beam orthogonal to the active area. One example which can be used of the PSD is a duolateral two-dimensional solid-state position-sensing detector from On-Trak Photonics (Lake Forest, Calif., U.S.A.). These detectors have linearity better than 0.3% and analogue resolution less than 1 ppm. The response time is on the order of 10 μsec.

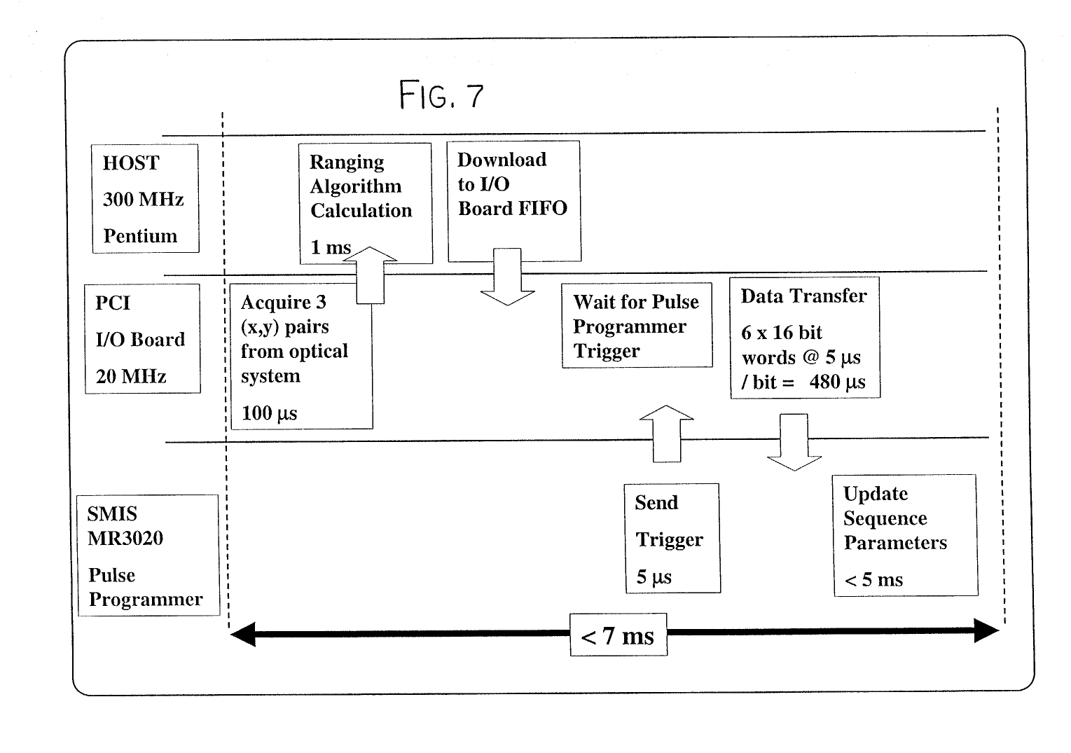

As shown in FIG. 7, each PSD produces two output currents, which are proportional to the displacement in (x, y) on the surface of the PSD. These currents are converted to voltages and amplified by the appropriate On-Trak Photonics amplifiers.

The unique property of trihedral cube-corner retro-reflectors is that a reflected beam will emerge parallel and displaced with respect to the incoming beam. This displacement is equal to twice the displacement of the incoming beam with respect to the virtual apex of the reflector and is independent of any rotation of the reflector about the virtual apex. The virtual apex is slightly displaced from the physical apex position due to the difference in refractive index between air and glass. One example of the cube-corner retro-reflectors are solid glass (material BK7), with diameter 25.4 mm, and were acquired from Edmund Industrial Optics (Barrington, N.J.).

An example of the laser diode modules which can be used, from Meredith Instruments (Glendale, Ariz.), have a wavelength of 650 nm and produce 5 mW of power.

An example of the beam splitter, from Edmund Industrial Optics (Barrington, N.J.), is required to ensure orthogonality of the reflected light beam to the surface of the PSD. It has a 50/50 ratio of reflected to transmitted light. Due to the beam splitter, each laser beam only delivers about 2.5 mW of power to its reflector. Nevertheless, to prevent even this weak light from reaching the subject's eyes, the forehead reflector is flanked by a cardboard baffle. Tests have shown that no reflected or scattered light can be seen in the magnet bore. To prevent interference by ambient light, a band pass filter is fitted between the beam splitter and PSD. The band pass filter has a centre wavelength of 650 nm and a Full Width Half Maximum of 10 nm.

To increase the system's field of view, the triangular platform on which the lasers and PSDs are mounted may be inverted relative to the frame of the reflectors, thus “crossing” the laser beams and doubling the altitude. Thus the convergence point of the laser beams is between the platform and the frame, instead of behind the reflectors. The same effect can be achieved by inverting the reflector frame.

The lasers and PSDs on their individual mounting heads are carried on the platform which is arranged at the end of the magnet facing into the magnet so as to direct the light beams into the magnet toward the sample. The platform is arranged so that the point of convergence is preferably on the longitudinal axis of the magnet which defines the Z-axis. The lasers are arranged at equidistantly spaced positions around the annular mounting platform.

The equilateral triangle forming the frame for the retro-reflectors is adjusted so that it lies approximately in a plane at right angles to the axis with the centre of the triangle lying approximately on the axis. The frame is mounted onto the sample by a suitable mounting arrangement so that it remains fixed relative to the sample. For different samples, suitable mounting arrangements can be designed by one skilled in the art to allow the array of reflectors to remain stationary relative to the sample and thus to move as the sample moves.

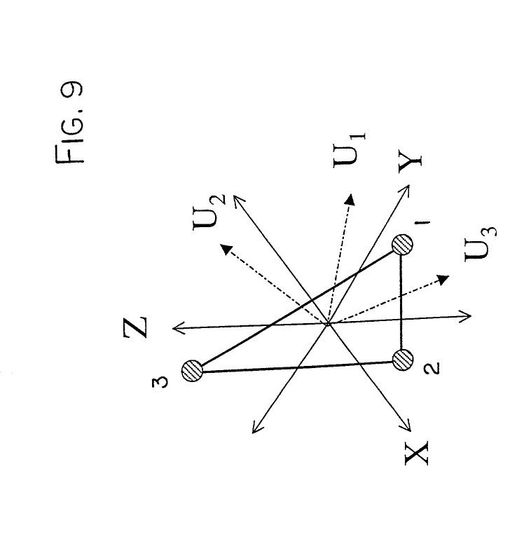

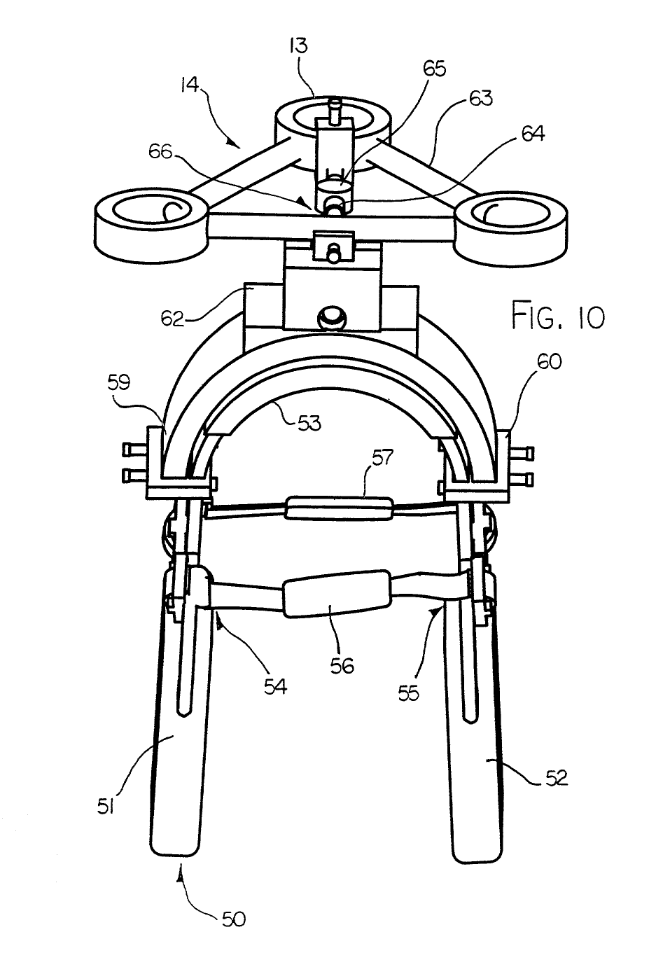

In FIGS. 9 and 10 there is shown a particular arrangement of mounting assembly by which the array is attached to the head of a patient, particularly bearing in mind that a primary function of the NMR system is to provide imaging of the head of a patient.

It is well known that the patient in an NMR magnet must often wear earplugs and/or headphones in order to drown the noises generated by the oscillation of the magnetic field which unfortunately occur at audible range and to provide communication with or for auditory stimulation for the patient in functional MRI.

The headphones are generally indicated in FIGS. 9 and 10 at 50. The headphones comprise two ear covers 51 and 52 which are attached to a band 53 which extends over the top of the head of the patient. An adjustable mounting 54 and 55 for each ear cover allows careful positioning of the ear cover relative to the head of the patient while the band 53 lies tight across the top of the patient's head to ensure that the structure remains tightly and fixedly in place.

The conventional headphones 50 are supplemented in the present arrangement by front and rear straps 56 and 57 which connect to the sides of the band 53 just above the mountings 54 and 55. Each strap thus extends around part of the head of the patient so that the front strap engages across the forehead and the rear strap engages around the back of the head. These straps can be adjusted and pulled tight to ensure that the mounting points 54 and 55 remain fixed just over the ears of the patient despite movement of the head of the patient.

The mounting assembly further includes an arch member which extends over the band and is spaced from the head of the wearer so as to provide a fixed arch carried wholly upon two clamps 59 and 60 each of which attaches to the band 53 just above the mounting 54, 55. The arch member thus is held in place over the top of the head of the patient and moves in three translational directions and in rotation about three axes with the head of the patient.

At the top of the arch member is mounted a fitting 62 which carries a ball joint 63. The frame 14 comprises three bars forming a triangle with one of the reflectors 13 located at each apex of the triangle. Across the bars 63 of the frame is provided a centre cross bar 64 which defines a centre point 65 of the frame at which is mounted a pin 66 extending at right angles from the frame and connected to the ball joint 63. The pin 66 can thus rotate about an axis at right angles to the frame relative to the fitting 62. The mounting 65 can slide along the centre rod 64 so as to adjust the frame 14 so that the centre of the frame lies on the central axis of the magnet while the head of the patient may be slightly offset from the centre of the magnet. Also people have heads of different sizes and shapes, and this way the alignment between the reflectors and the lasers can be optimised regardless of head shape and position (within limits).

Thus the frame 14 can be mounted so that with the patient's head at the position as determined by the location of the patient, the frame is moved and adjusted so that it lies initially at right angles to the Z axis of the magnet and is substantially centred on the Z axis of the magnet. Rotation of the frame about the Z axis then acts to locate each of the reflectors so as to intercept a respective one of the beams.

The preferred arrangement described above includes the use of retroreflectors which reflect beams transmitted from sources on the platform. The system can also use sources mounted on the sample which co-operate with position sensing devices on the platform to generate the required three pairs of signals. Yet further in an alternative arrangement, the three position sensing detectors can be provided in an arrangement in which each position sensing detector includes a mirror which directs the beam to a single photodetector which acts for all three sensing detectors in a time multiplexing operation. Thus the three position sensing detectors are together defined by three mirrors, a single sensor and a time multiplexing arrangement which allows the single sensor to co-operate with the respective light beam at selected, separate, sequential times to generate for each beam the two required signals.

It will be appreciated therefore that the calculation and the use of the system in MRI are not limited to the retroreflector arrangement and the system can be operated using alternative constructions to generate the required three pairs of signals which are used in the calculation to generate the required movement information which is then used in the MRI process. The use of at least one solid state, non-imaging photodetector is particularly advantageous since it provides as the output two signals representative of a position in a plane of the position sensing detector of the point of incidence of a light source on the plane.

Turning now to the calculation of the position of the array frame from the signals from the position sensing detectors, one example of the data acquisition board, is a multipurpose I/O board from National Instruments (Austin, Tex., U.S.A.), which samples the voltage inputs from the PSD amplifiers at a rate of 17 kHz/channel, at 16-bit resolution.

The six voltage outputs from the PSD amplifiers are read into a National Instruments data acquisition board, and digitised into three pairs of numbers, representing the (x,y) coordinates of the three reflected beams in the sensor planes of their respective PSDs. Calibration of these numbers into displacements (in mm) on the surface of each PSD is performed in LabVIEW. As the subject moves relative to the three fixed laser-PSD platforms, only the six PSD outputs change. The geometry parameters and the displacements are passed to C routines, which carry out the calculations described below.

A ranging algorithm is used to calculate the position of the body-mounted retro-reflectors relative to the magnet and imaging gradient coils. Since the retro-reflector frame is rigidly attached to a body part, the reflector coordinates are a direct measure of the translational and rotational motion of the subject, continually changing as s/he moves in the magnet.

The determination of the subject's position is approached in two parts. First, the PSD measurements of the reflectors'positions, at a given instant, are converted to their three-dimensional (3D) Cartesian coordinates in a pre-defined coordinate system attached to the magnet. The coordinates use the axis of the bore of the magnet as the Z-axis of the coordinate system, and locate the origin of coordinates at the magnetic centre of the gradients, to facilitate correction. Second, the retro-reflector coordinates are converted into the position and orientation of the retro-reflector frame at that instant. The position and orientation each require three numbers for their specification. In a series of measurements over time, changes in the six measured PSD-coordinates due to reflector motion are related to the actual translations and rotations that the subject is undergoing. The computations involved require only a very short time, of the order of milliseconds—much less than the interval between successive image acquisitions—and may therefore proceed in real time.

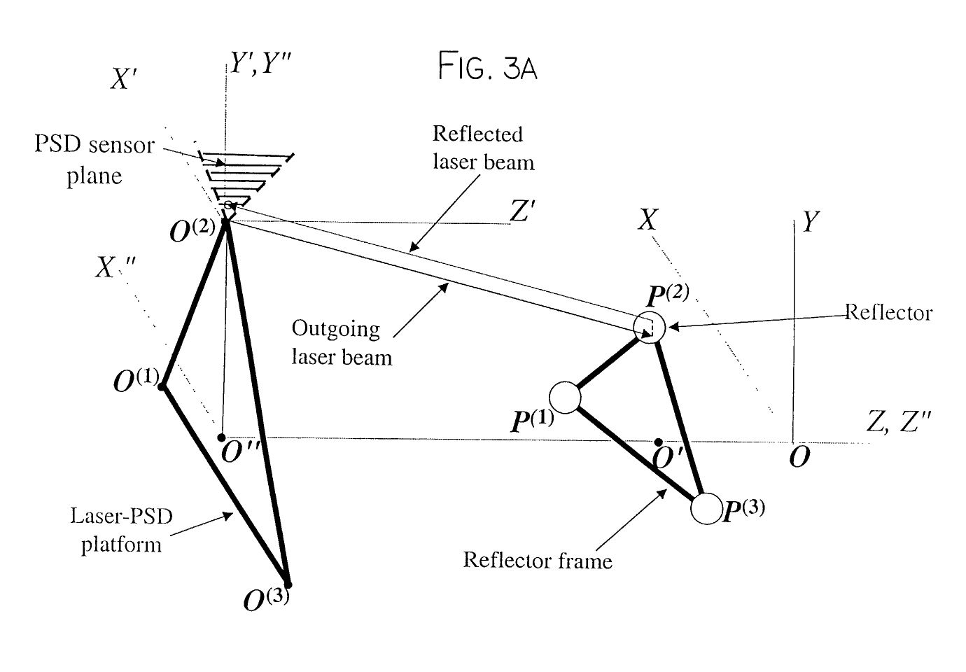

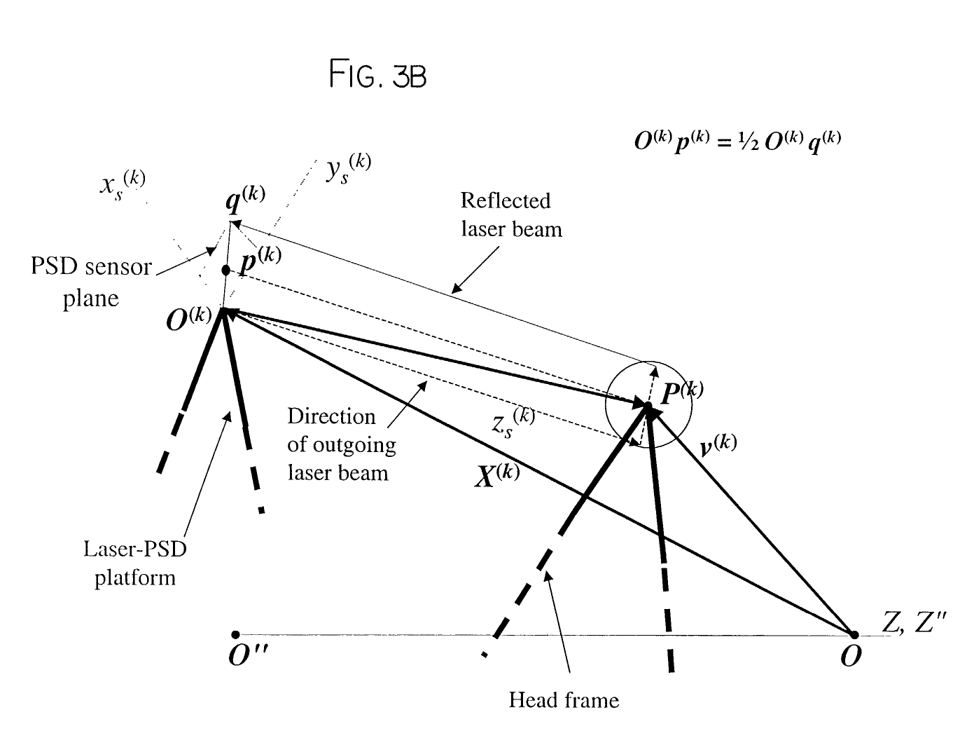

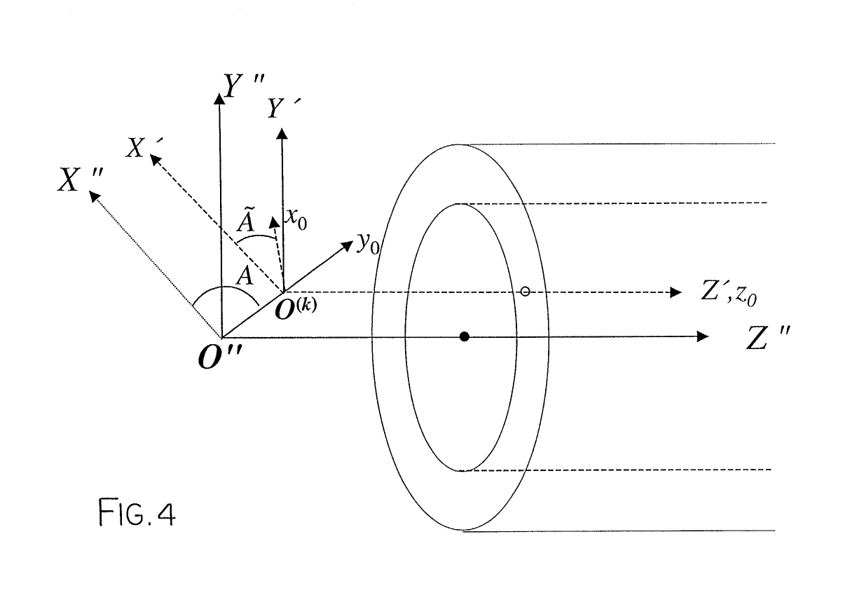

For the first part, the orientation and position information available for each laser-PSD platform, as well as current sensor-plane coordinates, are used to provide the 3D Cartesian coordinates of the retro-reflectors on the frame attached to the subject. This is achieved using a ranging technique to obtain the three distances between each PSD and its corresponding retro-reflector. From FIG. 3A, let the virtual apexes of the three retro-reflectors be located at P⁽¹⁾, P⁽²⁾, and P⁽³⁾, where P^{(k)} has coordinates (x^{(k)},y^{(k)},z^{(k)}) in the magnet coordinate system, for k=1,2,3. The laser-PSD units are mounted independently on the platform. O is a pre-defined origin of magnet coordinates, and OZ is the horizontal axis of symmetry of the magnet bore. OY is vertical, so that OX is horizontal and directed away from the observer. O″X″Y″Z″ is parallel to the magnet axes, with origin located at the point of intersection of the magnet bore axis and the plane of the laser-PSD platform. The laser-PSD units are attached to the platform. The origins of the coordinate systems of these units are located at O⁽¹⁾, O⁽²⁾, and O⁽³⁾, where each O^{(k)} has magnet-system coordinates (X^{(k)},y^{(k)},Z^{(k)}), and coincides with the origin of the sensor planes of its respective PSD. As shown in FIGS. 3A and 4, O^{(k)}X′Y′Z′ is parallel to the magnet axes, with origin O^{(k)}. The O^{(k)}s are defined as the points where the outgoing laser beams intersect the beam splitter (see FIG. 2). The laser beam located on laser-PSD unit k is directed along O^{(k)}zₛ^{(k)} to strike the reflector whose virtual apex is at P^{(k)}. The virtual apex is slightly displaced from the physical apex position due to the difference in refractive index between air and glass. After a second reflection at a point on the reflector on the opposite side of the virtual apex P^{(k)}, the beam returns in an anti-parallel direction to strike the PSD sensor plane at point q^{(k)}(Xₛ^{(k)}yₛ^{(k)}) (see FIG. 3B). Note that, unless the laser beam strikes the virtual apex (P^{(k)}) of the reflector, the reflected beam will be displaced from the incident beam, and hence will be sensed by the PSD at some distance away from its origin O^{(k)}, as shown in FIG. 3B. Due to the double reflection in the reflector, this vector displacement will be twice the actual displacement of the reflector virtual apex P^{(k)}. This is shown in FIG. 3B, where the point P^{(k)} halfway between O^{(k)} and q^{(k)} represents the actual displacement of the outgoing beam from the virtual apex P^{(k)}. Furthermore, the reflected beam will undergo a second reflection by the beam splitter. For simplicity, the following will refer to the projected sensor plane, shown in FIG. 2 located prior to the beam splitter, as the “sensor plane”. Therefore, it will be necessary to incorporate these two effects in the transformations described below.

Let X^{(k)} be the vector from the origin ) of magnet coordinates to O^{(k)}. The components of this vector in the magnet coordinate system can be pre-computed from the geometry of the system, with fixed orientations of the laser-PSD units. The vectors X^{(k)}, k:=1,2,3 are, therefore, independent of subject movement. The vector OP^{(k)}, denoted by v^{(k)}, specifying the position of the reflector, is then given by

v^{(k)}=X^{(k)}+O^{(k)}P^{(k)} (1)

for each of the three PSDs k:=1, 2, and 3.

The sensor plane of each PSD, together with its normal axis O^{(k)}zₛ^{(k)}, define a coordinate system O^{(k)}Xₛ^{(k)}yₛ^{(k)}zₛ^{(k)} whose orientation relative to the magnet coordinate system OXYZ is known. Let R^{(k)} denote the rotation (orthogonal) matrix describing this orientation. An expression for R^{(k)} is given below in Equ. (5). Then, the components of the vector O^{(k)}P^{(k)} denoted by (X^{(k)′}, y^{(k)′}, Z^{(k)′}) in the magnet coordinate system are

$$[ \begin{matrix}{x}^{( k ) ′} \\ {y}^{( k ) ′} \\ {z}^{( k ) ′}\end{matrix} ] = {R}^{( k )} [ \begin{matrix}{x}_{s}^{( k )} \\ {y}_{s}^{( k )} \\ {z}_{s}^{( k )}\end{matrix} ] \qquad ( 2 )$$

The components xₛ^{(k)},yₛ^{(k)} of the reflected beam are known from the PSD measurements, so the following may separate the unknown range zₛ^{(k)} by writing R^{(k)} as

R^{(k)}=[R₁₂^{(k)},r₃^{(k)}]

R₁₂=[r₁^{(k)},r₂^{(k)}] (3)

where r₁^{(k)}, r₂^{(k)}, r₃^{(k)} are orthogonal column unit vectors along the axes of the PSD coordinate system O^{(k)}xₛ^{(k)}yₛ^{(k)}zₛ^{(k)}. Then, Eq. (2) may be expressed in the form

$$[ \begin{matrix}{x}_{s}^{( k ) ′} \\ {y}_{s}^{( k ) ′} \\ {z}_{s}^{( k ) ′}\end{matrix} ] = {R}_{12}^{( k )} [ \begin{matrix}{x}_{s}^{( k )} \\ {y}_{s}^{( k )}\end{matrix} ] + {r}_{s}^{( k )} {z}_{s}^{( k )} \qquad ( 4 )$$

The first term on the right-hand side is the vector O^{(k)}p^{(k)} in FIG. 3B, and the second term is the vector p^{(k)}P^{(k)}, both expressed in magnet coordinates. Define the quantities

$${β}^{( k )} = {X}^{( k )} + {R}_{12}^{( k )} [ \begin{matrix}{x}_{s}^{( k )} \\ {y}_{s}^{( k )}\end{matrix} ] \qquad ( 5 )$$

The β^{(k)} are defined in terms of measured quantities only, and therefore can be calculated from the geometry of the PSDs attached to the platform and input PSD measurements. Then, Eq. (1) becomes

v^{(k)}=β^{(k)}+r₃^{(k)}zₛ^{(k)} (6)

Since the reflector frame is rigid, the distances dⱼₖ between the reflectors are fixed (and known). Thus, there are three constraints of the form

|v^{(j)}=v^{(k)}|²=dⱼₖ² (7)

where (j,k)=(1,2), (2,3) and (3,1). Defining the (vector) quantities

Dⱼₖ=β^{(k)}−^{(j)} (8)

We may substitute Eq. (6) into Eq. (7) to obtain the following set of three quadratic equations in the unknown ranges zₛ⁽¹⁾, zₛ⁽²⁾, and zₛ⁽³⁾:

zₛ^{(j)})²+(zₛ^{(k)})² −2(r₃^{(j)}·r₃^{(k)}) zₛ^{(j)}zₛ^{(k)}+2(Dⱼₖ·r₃^{(k)})zₛ^{(k)}−2(Dⱼₖ·r₃^{(j)})zₛ^{(j)}+(Dⱼₖ²−dⱼₖ²)=0 (9)

To simplify notation, re-define zₛ^{(k)} as Zₖ, and define the constants

aⱼₖ=r₃^{(j)}·r₃^{(k)}

bⱼₖ=Dⱼₖ·r₃^{(k)}

cⱼₖ=Dⱼₖr₃^{(j)}

Δⱼₖ=Dⱼₖ²−dⱼₖ² (10)

Then, Eqs. (9) simplify to

zⱼ²+zₖ²−2aⱼₖzⱼzₖ+2bⱼₖzₖ−2cⱼₖzⱼ+Δⱼₖ=0 (11)

where (j,k)=(1,2), (2,3), or (3,1). The set of Eqs.(11) possesses 8 solutions (z₁,z₂,z₃) (some may occur as complex conjugate pairs), but only one of these will have physical interest.

A first solution of Eqs(11) is as follows. The ranges z₁,z₂,z₃ are most conveniently found by numerically solving the set of three simultaneous quadratic equations (11). The starting conditions for the method are determined from the geometry of the device: only approximate values are needed, since it was found that the method does not erroneously converge to any of the remaining 7 solutions of the equations. Using a globally convergent Newton-Raphson algorithm [2], the first computation converges within 30 steps, and later computations (using the previously calculated zₖ as the starting points) converge within 9 steps. Each cycle takes less than a msec on a Pentium II 300 MHz computer.

A second solution of Eqs.(11) follows from collaboration between M. E. Alexander and A. R. Summers. This method is preferred for the following reasons:

(i) Unlike the first method, the solution to Eqs.(11) may be found directly, without incurring an unknown number of iterations of computation that are required when using the Newton-Raphson algorithm of the first method above;

(ii) The equations to be solved at each instant are considerably simpler—and therefore computationally faster—than Eqs.(11);

(iii) The new method provides explicit values for each of the 8 possible solutions to Eqs.(11), and the choice as to which is the correct solution for the current configuration is made prior to beginning the measurements (xₛ^{(k)},yₛ^{(k)}) of the outputs of the position sensing detectors.

The second solution to Eqs.(11) is as follows. It may be shown that Eqs.(11) are equivalent to the following system of equations:

$$\begin{matrix}{ζ}_{j}^{2} + {ζ}_{k}^{2} - 2 {a}_{jk} {ζ}_{j} {ζ}_{k} - {d}_{jk}^{2} = 0 ; & ( 11 a ) \\ {b}_{jk}^{( ( ) )} = ( {X}^{( k )} - {X}^{( j )} ) {gr}_{3}^{( k )} ; {c}_{jk}^{( ( ) )} = ( {X}^{( k )} - {X}^{( j )} ) {gr}_{3}^{( j )} ; & ( 11 b ) \\ {b}_{jk}^{( 1 )} = [ ( {r}_{1}^{( k )} {x}_{s}^{( k )} + {r}_{2}^{( k )} {y}_{s}^{( k )} ) - ( {r}_{1}^{( j )} {x}_{s}^{( j )} + {r}_{2}^{( j )} {y}_{s}^{( j )} ) ] {gr}_{3}^{( k )} ; & ( 11 c ) \\ {c}_{jk}^{( 1 )} = [ ( {r}_{1}^{( k )} {x}_{s}^{( k )} + {r}_{2}^{( k )} {y}_{s}^{( k )} ) - ( {r}_{1}^{( j )} {x}_{s}^{( j )} + {r}_{2}^{( j )} {y}_{s}^{( j )} ) ] {gr}_{3}^{( j )} ; & ( 11 d ) \\ {z}_{j}^{( 0 )} = \frac{{c}_{jk}^{( 0 )} - {a}_{jk} {b}_{jk}^{( 0 )}}{1 - {a}_{jk}^{2}} - {ζ}_{j} & ( 11 e ) \\ {z}_{j}^{( 1 )} = \frac{{c}_{jk}^{( 1 )} - {a}_{jk} {b}_{jk}^{( 1 )}}{1 - {a}_{jk}^{2}} & ( 11 f ) \\ {z}_{j} = {z}_{j}^{( 0 )} + {z}_{j}^{( 1 )} ; & ( 11 g )\end{matrix}$$

where, (jk)=(1,2), (2,3) or (3,1), and r₁^{(k)}, r₂^{(k)},r₃^{(k)} are defined in Equations (3) and (15); X^{(k)} is defined prior to Equation (1); and aⱼₖ is defined in Equation (10). Equations (11a), (11b) and (11e) are expressed in terms of constants (independent of (xₛ^{(k)},yₛ^{(k)})) that are derived from the initial calibration of the system. Therefore, these equations are solved only once, prior to the commencement of the measurements of the outputs of the position sensing detectors. Equations (11a), in the unknown variables (ζ₁,ζ₂,ζ₃), have 8 solutions all of which may be computed directly, without requiring iteration of the computations. The correct solution for the given configuration can be chosen from among these 8, and used in Equation (11e) for all subsequent calculations of the object's position. Equations (11c), (11d), (11f) and (11g) include the measurements (xₛ^{(k)},yₛ^{(k)}) from the outputs of the position sensing detectors, and therefore are solved at each instant—that is, for each new measurement (xₛ^{(k)},yₛ^{(k)}).

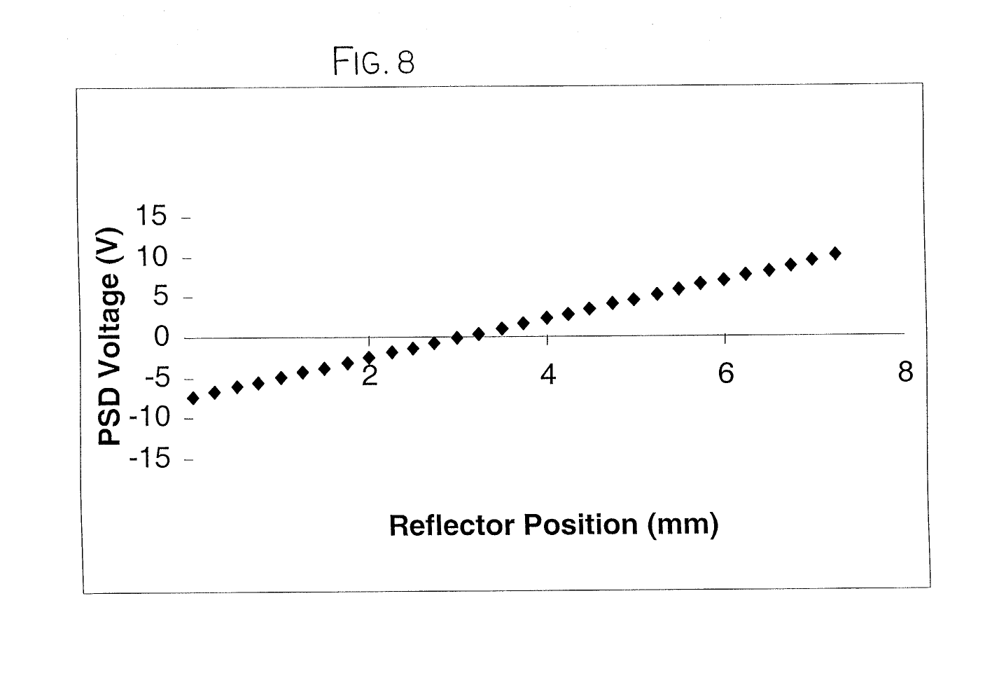

Having obtained z₁,z₂,z₃ they may be substituted back into Eq. (6) to obtain the coordinates of the reflectors v^{(k)}=(x^{(k)}, y^{(k)}, z^{(k)}), k=1,2,3. In the second step, the current position and orientation of the retro-reflector frame may be determined from these v^{(k)}s. The position of the retro-reflector frame may be defined as the centroid (T₁, T₂, T₃) of the three apexes of the retro-reflectors, and their orientation in terms of a set of orthonormal unit vectors, defined using the plane of the reflector frame, as follows [5]. The reflectors, as well as their corresponding laser-PSD units, are numbered 1,2,3 in a clockwise sense when looking onto the reflector frame from the laser-PSD platform. The origin of coordinates (T₁,T₂,T₃) is the centroid O′, say. Then, U₁ is directed from the centroid to the first reflector, U₂ is perpendicular to the frame and U₃ is perpendicular to both U₁ and U₂. See FIG. 8. The Euler angles (Φ,θ,Ψ) required to rotate the reflector frame axes into a parallel position with respect to the magnet coordinate system, define the current orientation of the frame.

The time course of subject motion is manifest by the changes in the six PSD coordinates (xₛ^{(k)}, yₛ^{(k)}), k=1, 2, 3. At each time point, Eqs.(11) are solved using the current set of inputs (xₛ^{(k)}, yₛ^{(k)}), to obtain the solution z₁,z₂,z₃ which is then used to compute the new (T₁,T₂,T₃, (Φ,θ,Ψ).

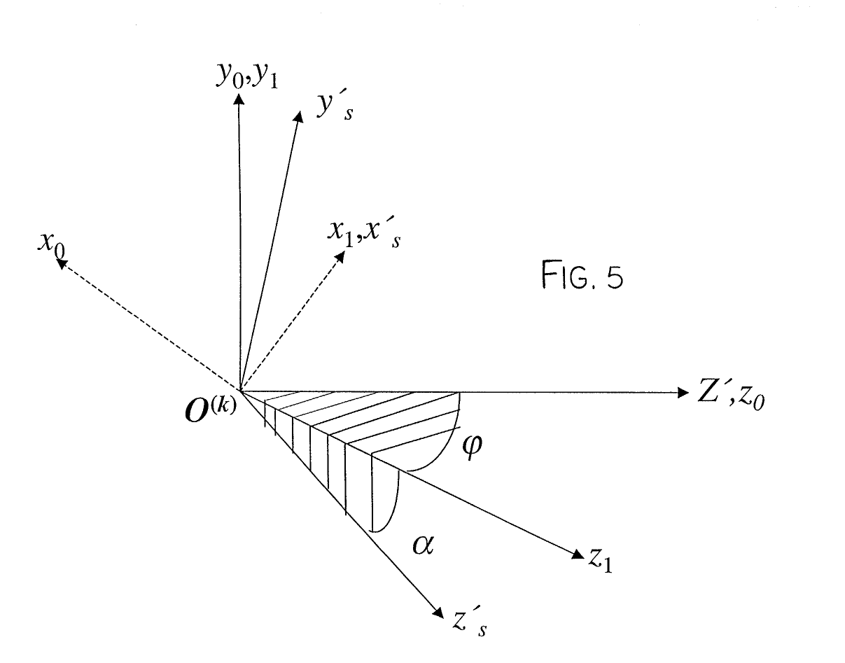

Referring to FIG. 4, let the platform containing the three laser-PSD units lie in the vertical O(^{k})X′Y′-plane. For k=1,2,3, the angle in the vertical O(^{k)}X′Y′-plane of the position of the k'th laser-PSD unit is defined with respect to the horizontal O^{(k)}X′-axis as A. Therefore, the plane )^{(k)}x₀y₀) is tilted by an angle Ã=A−½π to the horizontal. As shown in FIG. 5, the laser-PSD unit is allowed to swivel about the origin O^{(k)} in azimuth (that is, in the plane O^{(k)}x₀z₀) by angle φ, and dip perpendicular to this plane by angle α. For simplicity of notation in what follows, superscripts (k) on the angles are omitted and intermediate coordinate systems used to derive the rotational transformation below.

From FIG. 4, the transformation is derived between O^{(k)}x^{(k)}′,y^{(k)}′z^{(k)}′ and O^{(k)}x₀y₀z₀ coordinates:

$$( \begin{matrix}{x}^{( k ) ′} \\ {y}^{( k ) ′} \\ {z}^{( k ) ′}\end{matrix} ) = ( \begin{matrix}sin A & cos A & 0 \\ - cos A & sin A & 0 \\ 0 & 0 & 1\end{matrix} ) ( \begin{matrix}{x}_{0} \\ {y}_{0} \\ {z}_{0}\end{matrix} ) \qquad ( 12 )$$

where A is substituted for the tilt angle of the platform Ã using the above expression. From FIG. 5, there is similarly derived

$$\begin{matrix}( \begin{matrix}{x}_{0} \\ {y}_{0} \\ {z}_{0}\end{matrix} ) = ( \begin{matrix}cos ϕ & 0 & - sin ϕ \\ 0 & 1 & 0 \\ sin ϕ & 0 & cos ϕ\end{matrix} ) ( \begin{matrix}{x}_{1} \\ {y}_{1} \\ {z}_{1}\end{matrix} ) & ( 13 ) \\ ( \begin{matrix}{x}_{1} \\ {y}_{1} \\ {z}_{1}\end{matrix} ) = ( \begin{matrix}1 & 0 & 0 \\ 0 & cos α & - sin α \\ 0 & sin α & cos α\end{matrix} ) ( \begin{matrix}{x}_{s}^{′} \\ {y}_{s}^{′} \\ {z}_{s}^{′}\end{matrix} ) & ( 14 )\end{matrix}$$

If we denote the rotation matrices appearing on the right-hand sides of Eqs.(12)-(14) by R_{A}, R_{Φ}, and R_{α}, respectively, then their composition, represented by rotation matrix R^{(k)} in Eq.(2), may be expressed as

R^{(k)}=R_{A}R_{Φ}R_{α} (15)

In the proposed system, we set the azimuth Φ=0 for each laser-PSD unit. This implies that the laser beams are tilted in the radial plane containing the magnet bore axis and passing through the origin O^{(k)}. During the acquisition of a series of images, the angles A and α are fixed, so that subject motion manifests itself solely by the time-varying displacements of the coordinates (xₛ^{(k)},yₛ^{(k)}) of the reflected laser beams in the three PSD measuring planes.

Once subject motion has been detected, our package allows the user to choose one of two modes:

Motion display, in which the displacements of the subject's position, as calculated above, can be followed on a computer video monitor, as well as being recorded in a file, so the experiment can be halted and restarted if necessary. The images can be corrected after the fact by means of conventional post-processing techniques. The advantage to this mode is that it does not require any changes to the pulse programmer, while still giving the user full access to the motion information.

Acquisition correction, in which the displacements, as calculated above, are sent to the pulse programmer, modifying the next gradient pulse sequence and correcting the image online. The displacements are also recorded in a file for later reference and flagging of any images in which the correction may have been incomplete, for additional processing. This mode is described in greater detail below.

The motion correction system was developed for the Innovative Magnetic Resonance Imaging Systems (IMRIS, Winnipeg, MB, Canada) 3T head-only MRI system, comprising a 3T magnet from Magnex Scientific, Ltd. (Abingdon, U.K.) and a console from Surrey Medical Imaging Systems (SMIS, U.K.). However, it can be easily implemented on other systems.

Positional information from the detection system can be fed back directly into the acquisition MR system so that the motion of the reflectors is compensated for in the resulting images. Any MR visible material rigidly attached to the reflectors should then appear motionless in the resulting images. In the case that the imaged anatomy is not rigidly attached to the reflectors, then additional calculations and data processing can be performed and the expected position of the anatomy can be used in place of the raw reflector positions. In cases where the position detection is performed significantly earlier than the time that the position correction is required (for example the moment of slice selection), then velocity information (the differential of the position) can be used to predict the future position. For more accuracy higher orders of motion (acceleration, jerk, etc.) could also be used to predict future body part position. In our present implementation we use the raw detected position as the basis for correction. This is equivalent to assumptions of rigid attachment and zero detection-correction time lag.

We interface the motion detection PC with the SMIS pulse programmer using a TTL digital output stream of bits, generated by a National Instruments multipurpose I/O board (featuring direct memory access DMA, and PCI interface), with software written in LabVIEW. This board is connected to the console's pulse programmer input port, configured to function as a fast serial interface. Each download of 6 16 bit parameters takes less than 1 msec. Faster download times could be achieved using shorter bits (reduce to 5 μsec from 10 μsec) and the use of more than one input line. Another possibility is the transfer of less data, e.g., four parameters for echo planar imaging (EPI) instead of six for two-dimensional Fourier transform imaging (2DFT)—see below.

For orientation correction three new patient orientation angles (rotations about the X,Y,Z axes) are passed to the pulse programmer every correction cycle. The gradient matrix calculation, for implementing rotational corrections, is done on the SMIS MR3040 board, employing these updated orientations. All the additional pulse programmer operations are concluded in less than 5 msec. Enhanced speeds would be possible with pulse sequence optimisation. For translational corrections 3 field-of-view (FOV) shifts are passed to the pulse programmer every cycle, which are used to calculate spectrometer frequencies and phases. Translations are carried out in the (read, phase, slice) image coordinate system.

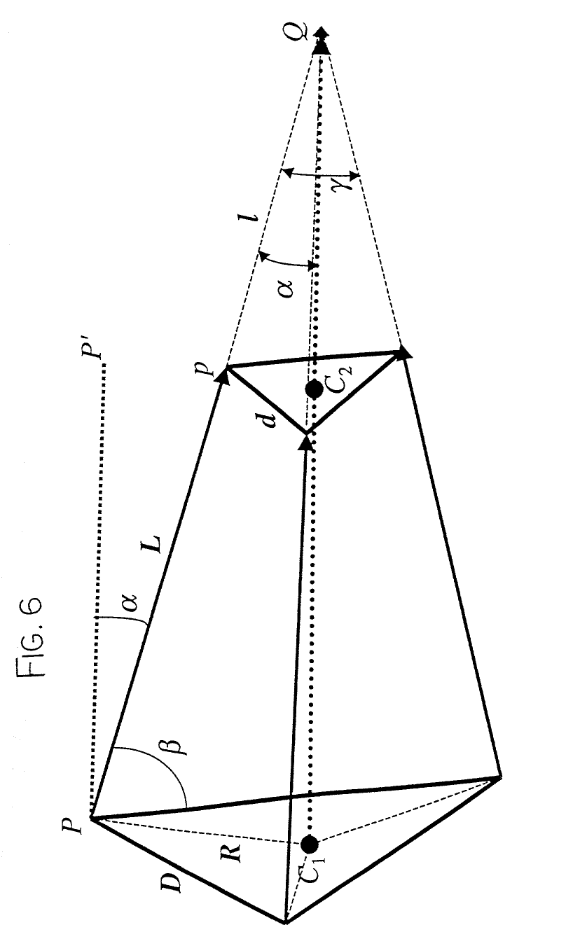

For 2DFT, the entire correction can be carried out in this manner. For EPI, only rotations and the slice direction translation can be corrected in this way, and the (read, phase) translations must be corrected in software, before reconstruction. However, since the system is so fast, these corrections still appear to the user to be happening in real time. See FIG. 6 for the timing diagrams.

Corrections can be performed at least for every phase-encoding step for 2DFT (spin-warp), and for every image for EPI (echo planar imaging). For some applications it may be beneficial to perform corrections even faster than this, with multiple corrections between excitation and data acquisition (i.e. within the echo-time). This level of time resolution is unavailable for navigator echo detection methods.

This system is implemented with a set of three reflectors attached to the top of the head. The detectors may be attached to other body parts and more than one set of reflectors and detectors could in principle be used for monitoring more than one body part simultaneously.

If a body part is non-rigid then the data from a single set of reflectors/detectors may be insufficient to fully characterise the motion and deformation of the body part.

The brain is not rigidly attached to the skull or scalp. Monitoring of scalp position therefore may not always reflect accurately brain position and orientation. In these cases it may however be possible to deduce the brain position by using the scalp position and also additional information. These might include biomechanical models of the head, use of the time course of motion to calculate velocity and acceleration and other dynamic parameters, as well as additional physical measurements.

This system is capable of detecting head motions. It is thus possible to use this a one way communication method from the patient to the operator (nodding, shaking the head etc.) as an alternative to verbal communication.

It is also possible to use the motion detector output as the basis of a biofeedback system to train subjects to remain motionless, or for other functions.

It is possible to use the system to assess a patient and to modify the examination protocol and duration accordingly. Subjects exhibiting a lot of motion may require the selection of less motion sensitive MR protocols.

Additional optical processing steps using standard components such as lenses, mirrors, beam splitters may be used. Some examples follow:

Lens systems can be used to magnify the reflected beams to decrease inaccuracies associated with the PSD.

Lens systems can be used to reduce the apparent size of the reflected beam, requiring a smaller area of active PSD for detection.

To achieve a larger beam displacement for a given reflector motion (for example higher spatial resolution) the image of the reflector can be magnified using a lens system. (This will reduce the range of motion detectable before the reflected beam no longer strikes the detector.)

To achieve a smaller beam displacement for a given reflector motion (i.e. lower spatial resolution) the image of the reflector can be reduced using a lens system.

The resolution of the system is not diffraction limited, so the detection system described is capable of measuring motion in 3D at extremely high spatial resolution. This could function as detection of motion on a sub-microscopic scale.

Since various modifications can be made in the invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A method for detecting movement of a sample comprising:
providing three retro-reflectors:
rigidly attaching the three retro-reflectors in an array to the sample such that movement of the object effects movement of one, two or all of the retro-reflectors, depending upon the movement of the sample;
providing three light sources, each arranged to direct an incident light beam onto a respective one of the retro-reflectors such that the incident beam is reflected from the respective retro-reflector to generate a reflected beam which is parallel to the incident light beam and which is off-set from the incident beam by a distance dependent upon the position of the respective retro-reflector relative to the incident beam;
arranging three position sensing detectors such that each receives a respective one of the reflected light beams and so as to generate an output comprising two signals representative of a position in a plane of the position sensing detector of the point of incidence of the reflected beam on the plane such that the two signals provide information relating to the position of the respective retro-reflector;
mounting the light sources and the position sensing detectors in fixed relative positions on a platform so as to direct the incident light beams onto the respective retro-reflectors with the incident beams non-parallel;
and in response to the two signals from each of the three position sensing detectors effecting a calculation of information defining the movement of the object about three rotational axes and in three translational directions.

2. The method according to claim 1 wherein the two signals from the position sensing detectors are in analogue form and there is provided an analogue to digital converter for converting the signals to digital values for the calculation.

3. The method according to claim 2 wherein the calculation is arranged:
firstly to calculate from the digital values of the three position sensing detectors for each position sensing detector and its associated retro-reflector a distance between a fixed point in the plane of the position sensing detector and a predetermined point in the respective retro-reflector;
and secondly to calculate, from said distances and from information defining the geometry of the position sensing detectors on said platform and the geometry of the retro-reflectors in said array, the coordinates of the predetermined points of the retro-reflectors relative to a reference point which is fixed relative to the platform.

4. The method according to claim 3 wherein the predetermined point of each of the retro-reflectors is located at the virtual apex thereof.

5. The method according to claim 3 wherein the calculation uses the following formula:
zⱼ²+zₖ²−2aⱼₖzⱼzₖ+2bⱼₖzₖ−2cⱼₖzⱼ+Δⱼₖ=0 (11)
where the terms of the equation are as set out in the specification.

6. The method according to claim 3 wherein the output of the algorithm consists of six floating point numbers which represent the three components of the displacements of the sample along the axes of a coordinate frame based upon the fixed point, and the three Euler angles describing the orientation of the sample with respect to these axes.

7. The method according to claim 1 wherein each light source and its associated position sensing detector includes a beam splitter for directing the reflected beam at an angle to the incident light beam for detection.

8. The method according to claim 1 wherein the light sources are arranged on the platform at apexes of a triangle in a plane of the platform such that the beams are projected to one side of the plane containing the light sources and such that the beams converge with each other.

9. The method according to claim 1 wherein the beams converge with each other at an angle which is the maximum which can be accommodated for the geometry concerned.

10. The method according to claim 1 wherein position sensing detectors are solid state, non-imaging photodetectors.

11. The method according to claim 1 wherein the retro-reflectors are mounted on a frame at apexes of a triangle, the frame being attached to the sample for movement therewith.

12. The method according to claim 1 including the steps of performing magnetic resonance measurements to provide information relating to the sample by:
providing at least one magnet generating a magnetic field;
providing at least one gradient field coil and applying a field signal to the coil resulting in a magnetic field which in addition to the field of the magnet is applied to form a variable magnetic field in which the sample is located;
providing at least one radiofrequency (RF) coil and applying an RF signal to the RF coil to generate an RF field;
detecting RF signals from the sample caused by nuclear magnetic resonance in the sample;
analyzing the RF signals to determine information relating to the sample;
and, during the nuclear magnetic resonance measurements, using the information defining the movement of the object about three rotational axes and in three translational directions to compensate for movement of the sample such that the information relating to the sample is independent of any movement of the sample.

13. The method according to claim 12 wherein the sample comprises the head of a patient, wherein there is provided a set of headphones worn by the patient while in the magnet and wherein the retro-reflectors are mounted on a frame attached to the headphones.

14. The method according to claim 13 wherein the frame includes an arch member attached to the headphones at sides of a strap thereof and bridging a top of the head of the patient and a array frame carrying the retro-reflectors and attached at a top of the arch member so as to lie in a plane generally across the top of the arch member.

15. The method according to claim 14 wherein the array frame is mounted on a swivel joint relative to the arch member so as to allow adjustment of the orientation of the array frame relative to the head of the patient.

16. A method for detecting movement of a sample comprising:
providing three non-parallel light beams each transmitted from a respective element located at a respective position on the sample;
providing three position sensing detectors and arranging the detectors at fixed positions on a platform such that each receives a respective one of the light beams and generates an output comprising two signals representative of a position in a plane of the position sensing detector of the point of incidence of the light beam, such that the signals are dependent upon movement of the sample and the elements thereon;
and effecting a calculation from the signals in digital values wherein the calculation is arranged:
firstly to calculate from the digital values of the three position sensing detectors for each position sensing detector and its associated element a distance between a fixed point in the plane of the position sensing detector and a predetermined point in the respective element;
and secondly to calculate, from said distances and from information defining the geometry of the position sensing detectors on said platform and the geometry of the elements on the sample, the coordinates of the predetermined points of the elements relative to a point at the sample which is fixed relative to the platform.

17. The method according to claim 16 wherein the calculation uses the following formula:
zₕ²+zₖ²−2aⱼₖzⱼzₖ+2bⱼₖzₖ2cⱼₖzⱼ+Δⱼₖ=0 (11)
where the terms of the equation are as set out in the specification.

18. The method according to claim 16 wherein the output of the algorithm consists of six floating point numbers which represent the three components of the displacements of the sample along the axes of a coordinate frame based upon the fixed point, and the three Euler angles describing the orientation of the sample with respect to these axes.

19. A method of performing magnetic resonance measurements to analyze a sample, comprising:
providing at least one magnet generating a magnetic field;
providing at least one gradient field coil and applying a field signal to the coil resulting in a magnetic field which in addition to the field of the magnet is applied to form a variable magnetic field in which the sample is located;
providing at least one radiofrequency (RF) coil and applying an RF signal to the RF coil to generate an RF field;
detecting RF signals from the sample caused by nuclear magnetic resonance in the sample;
analyzing the RF signals to determine information relating to the sample;
during the nuclear magnetic resonance measurements, detecting movements of the sample by a motion detection system which is separate from the nuclear magnetic resonance measurements to generate motion signals indicative of the movement;
and, during the nuclear magnetic resonance measurements, using the motion signals to compensate for the movement such that the information is independent of the movement.

20. The method according to claim 19 wherein the motion detector system includes at least one solid state, non-imaging photodetector, the output of which comprises two signals representative of a position in a plane of the position sensing detector of the point of incidence of a light source on the plane.

21. The method according to claim 19 including:
providing three light sources each transmitted from a respective element located at a respective position on the sample;
providing three position sensing detectors and arranging the detectors at fixed positions on a platform such that each receives light from a respective one of the light sources and generates an output comprising two signals representative of a position in a plane of the position sensing detector of the point of incidence of the light, such that the signals are dependent upon movement of the sample and the elements thereon;
and effecting a calculation from the signals in digital values wherein the calculation is arranged:
firstly to calculate from the digital values of the three position sensing detectors for each position sensing detector and its associated element a distance between a fixed point in the plane of the position sensing detector and a predetermined point in the respective element;
and secondly to calculate, from said distances and from information defining the geometry of the position sensing detectors on said platform and the geometry of the elements on the sample, the coordinates of the predetermined points of the elements relative to a point at the sample which is fixed relative to the platform.

22. The method according to claim 21 wherein the calculation uses the following formula:
zⱼ²+zₖ²−2aⱼₖzⱼzₖ+2bⱼₖzₖ−2cⱼₖzⱼ+Δⱼₖ=0 (11)
where the terms of the equation are as set out in the specification.

23. The method according to claim 21 wherein the output of the algorithm consists of six floating point numbers which represent the three components of the displacements of the sample along the axes of a coordinate frame based upon the fixed point, and the three Euler angles describing the orientation of the sample with respect to these axes.

24. The method according to claim 21 wherein each position sensing detector comprises a solid state, non-imaging photodetector, the output of which comprises two signals representative of a position in a plane of the position sensing detector of the point of incidence of the light source on the plane.

25. The method according to claim 21 wherein the sample comprises the head of a patient, wherein there is provided a set of headphones worn by the patient while in the magnet and wherein the retro-reflectors are mounted on a frame attached to the headphones.

26. The method according to claim 25 wherein the frame includes an arch member attached to the headphones at sides of a strap thereof and bridging a top of the head of the patient and a array frame carrying the retro-reflectors and attached at a top of the arch member so as to lie in a plane generally across the top of the arch member.

27. The method according to claim 26 wherein the array frame is mounted on a swivel joint relative to the arch member so as to allow adjustment of the orientation of the array frame relative to the head of the patient.

28. A method for detecting movement of a sample comprising:
providing three light sources each transmitted from a respective element located at a respective position on the sample;
providing three position sensing detectors and arranging the detectors at fixed positions on a platform such that each receives light from a respective one of the light sources and generates an output comprising two signals representative of a position in a plane of the position sensing detector of the point of incidence of the light, such that the signals are dependent upon movement of the sample and the elements thereon;
and effecting a calculation from the signals in digital values wherein the calculation is arranged:
firstly to calculate from the digital values of the three position sensing detectors for each position sensing detector and its associated element a distance between a fixed point in the plane of the position sensing detector and a predetermined point in the respective element;
and secondly to calculate, from said distances and from information defining the geometry of the position sensing detectors on said platform and the geometry of the elements on the sample, the coordinates of the predetermined points of the elements relative to a point at the sample which is fixed relative to the platform.

29. The method according to claim 28 wherein the calculation uses the following formula:
zⱼ²+zₖ²−2aⱼₖzⱼzₖ+2bⱼₖzₖ−2cⱼₖzⱼ+Δ=0 (11)
where the terms of the equation are as set out in the specification.

30. The method according to claim 28 wherein the output of the algorithm consists of six floating point numbers which represent the three components of the displacements of the sample along the axes of a coordinate frame based upon the fixed point, and the three Euler angles describing the orientation of the sample with respect to these axes.
